(19) United States
(12) Patent Application Publication
(10) Pub. No.: US 2006/0041432 A1
(43) Pub. Date: Feb. 23, 2006

(54) Method of improving physicians' productivity

(76) Inventor: Theda Benja-Athon, Port Washington, NY (US)

Correspondence Address: THEDA BENJA-ATHON, 14 BOGART AVENUE, PORT WASHINGTON, NY, 11050, US

(21) Appl. No.: 10/919,502

(22) Filed: Aug. 17, 2004

(51) Int. Cl. G10L 21/00

(52) U.S. Cl. 704/275

(57) ABSTRACT

A method of increasing physicians' productivity, securing the monetary payments for and due to physicians for the performed health-care services and reducing the economic loss and legal encumbrances being imposed on the physicians. The method comprises the processes wherein individual physicians, at anytime and anywhere, articulating data on performed treatments and procedures in spoken voice into a cordless microphone, wireless propagation of the data to a receiver, the transmission, processing and conversion of the data into monetary values thence payments for and the electronic transmission of the payments to the physicians.

### FIELD OF INVENTION

A method for optimizing the physicians' productivity.

### BACKGROUND OF THE INVENTION

The current American health-care system imposes enormous economic and legal hindrances and constraints on the practice of good medicine by physicians. Furthermore, said system not only strains the physicians and this nation, it also wastes or causes the loss of enormous precious physicians' time—several million physician hours per annum- and resources. Humanity has lost and suffered so much due to the encumbrances imposed by said system and the adjuncts.

The present invention increases the productivity of the physicians, reduces or, better yet, eliminates encumbrances and interferences being imposed on physicians. The present invention eliminates said encumbrances and waste so that tremendous amounts of physicians' time, concentration and creativity can benefit physicians, people and the nation. Furthermore, the present invention allows physicians to be optimally and efficaciously compensated, paid, and, better yet, rewarded for their work and endeavors. It provides the method whereby a physician or physicians is or are directly compensated for their services, works and endeavors provided to consumers of the health-care services without said physicians being compelled or obligated to spend—i.e. waste and lose—several million of physician hours per annum dealing with and doing paper-work such as, but not limited to, the production of notes, records and correspondences, filling forms and questionnaires, calls to get third-party approvals and answering to written and oral questions, in pursuit of compensation or payments owed and due to them for their performed services on patients.

### SUMMARY OF THE INVENTION

Despite numerous milestones achieved in health care in the last several decades in America, the delivery of health care and physicians' practice of medicine are stifled by encumbrances imposed by third parties entwined in the current health care system.

A method of increasing the productivity of, reducing stresses on and increasing the freedom of a physician or physicians whereby the unnecessary and cumbersome work and steps being imposed by the third parties, including non-physician players and participants in the current health-care system on American physicians in order for said physicians to be compensated for their work or performances are either circumvented, reduced or, better yet, eliminated.

The present invention is a method of increasing physicians' productivity, securing the monetary payments for and due to physicians for the performed health-care services and reducing the economic loss and legal encumbrances being imposed on the physicians. The method comprises the processes wherein individual physicians, at anytime and anywhere, articulating data on performed treatments and procedures in spoken voice into a cordless microphone, wireless propagation of the data to a receiver, the transmission, processing and conversion of the data into monetary values thence payments for and the electronic transmission of the payments to the physicians.

### DESCRIPTION OF THE PREFERRED EMBODIMENTS

The method comprises a physician's conversion or synthesis of said physician's data on a diagnosis, a plurality of diagnoses, a treatment, a plurality of treatments, procedure and/or a plurality of procedures performed by said physician on a patient formed or synthesized in said physician's brain and mind, upon prompting by said physician, into said physician's spoken voice data. Said voice data is articulated by said physician into a first receiver means for propagating said data such as, but not limited to, a microphone. Certain features of said microphone are compact, miniature, light, cordless or wireless adaptable to attach or secure to said physician's clothing, apparel and the like. In other words, one of the preferred embodiments of the present invention, said physician, at anywhere and anytime, forms or synthesizes the data on a diagnosis, a plurality of diagnoses, a treatment, a plurality of treatments, a procedure and/or a plurality of procedures performed by said physician on a patient in said physician's brain and mind. Upon prompting by said physician, said data is converted or synthesized into said physician's spoken voice data. Said physician articulates said spoken voice data into said microphone. Said voice data comprise number, numbers, word, words, phrase, phrases, sentence, sentences or any combination thereof.

Said voice data is transmitted from and by said microphone by a wireless means of transmitting data in the form such as, but not limited to, electromagnetics, to a second receiver means of receiving said data. Said voice data is further transmitted to a means for processing said data. Said means for processing said data includes a means for assigning or correlating individual monetary value or values to said number, numbers, word, words, phrase, phrases, sentence and sentences representing treatment, a plurality of treatments, a procedure and/or a plurality of procedures. In addition, the correlations between a monetary value and a treatment, a monetary value and a procedure, monetary values and treatments, monetary values and procedures and various and all permutations of said correlations are performed and stored in said means for processing.

Furthermore, the present invention includes a process of using a means for enumerating or tallying individual monetary values correlating with or relating to said monetary value and a treatment, monetary value and a procedure, monetary values and treatments, monetary values and procedures and various and all permutations of said correlations to determine the compensations or payments to be made to said physician or a plurality of physicians.

Consequently, the outcomes of the above enumeration or tally are transmitted to a means for effecting dispensations of monetary compensations relating to said treatment, plurality of treatments, procedure and/or plurality of procedures. In one of the preferred embodiments, a source for said means for effecting dispensations of monetary compensations or payments from a means for compensating are pools of monies that are formed or organized by the consumers, buyers or consumers-buyers of health-care services such as, but not limited to, patients, employees, retirees, dependents of employees and/or retirees, employers, government or any combination thereof. In other words, said consumers, buyers or consumers-buyers of the health-care services compensate or pay the physician or a plurality of physicians for the health-care services said patients received. The monies to pay said physicians come from a pool or pools of monies and resources formed by the finances and monies contributed or paid by said consumers, buyers or consumers-buyers of the health-care services.

Moreover, the present invention provides a process wherein said consumer, consumers, buyer, buyers, consumer-buyer or consumers-buyers of health-care services has or have the means for endorsing said dispensations of monetary compensations or payments relating to said treatment, plurality of treatments, procedure and/or plurality of procedures to said physicians. In other words, even though said physicians are paid from said pool or pools of monies and resources formed by the finances and monies contributed or paid by said consumers, buyers or consumers-buyers of the health-care services without any interference from said consumers, buyers or consumers-buyers of the health-care services, said patient, patients, employers, government representatives or the like is or are endowed by the present invention the ability to audit said processes and the ability to endorse, approve, disapprove or disallow any and all outcomes of said processes.

The present invention also provides a process of using an electronic means for transmitting said monetary compensation, compensations, payment or payments to said physician or physicians from said means for compensating. Said physician or physicians uses or use a means for complying with said electronic means for transmitting said monetary compensation or compensations in order to get possession of said compensations or payments.

In addition, using the above features of the present invention, the present invention further provides a method wherein a physician can effectively and conveniently document said physician's discussions including informed consents and explanations with a patient.

Although the preferred embodiments have been described, it will be appreciated by those skilled in art that variations, adaptations and applications of the present invention can be had without departing from the spirit of the invention and the scope of the claims.

1. A method of increasing the productivity of a physician wherein data comprising said physician's treatment, plurality of treatments of, procedure or plurality of procedures on a patient formed or synthesized in said physician's brain and mind, upon prompting by said physician, are converted or synthesized by said physician into said physician's spoken voice data, wherein said voice data is articulated by said physician and received by a first receiver means for propagating said data, wherein said data is transmitted by a wireless means for transmitting adaptable to propagate said data to a second receiver means for propagating said data adaptable to further propagate said data to a means for assigning or correlating individual monetary value or values to said treatment, plurality of treatments, procedure or plurality of procedures, a means for enumerating or tallying individual monetary values of said treatment, plurality of treatments, procedure or plurality of procedures and a means for effecting dispensations of monetary compensations relating to said treatment, plurality of treatments, procedure, plurality of procedures from a means for compensating formed by the consumers, buyers or consumers-buyers of health-care services to a physician, a plurality of physicians or to a receiver of compensation of a physician or a plurality of physicians comprises:
a process of converting said data into said physician's spoken voice data;
a process of synthesizing said data into said physician's spoken voice data;
a process of articulating said spoken voice data by said physician;
a process of articulating said voice data by said physician into a first receiver means for propagating said voice data;
a process of transmitting said voice data by a wireless means for transmitting data;
a process of transmitting said voice data by a wireless means for transmitting data to a second receiver means for propagating said data;
a process of using a means for assigning individual monetary value to a treatment;
a process of using a means for assigning individual monetary value to a procedure;
a process of using a means for assigning individual monetary values relating to a plurality of treatments;
a process of using a means for assigning individual monetary values to a plurality of procedures;
a process of using a means for tallying individual monetary values relating to a plurality of treatments;
a process of using a means for tallying individual monetary values relating to a plurality of procedures;
a process of effecting a dispensation of monetary compensations for a physician relating to a treatment or a plurality of treatments of a patient;
a process of effecting the dispensations of monetary compensations for a plurality of physicians relating to said physicians' treatments of a patient or a plurality of patients;
a process of effecting a dispensation of monetary compensations for a physician relating to said physician's treatment on a patient or a plurality of patients;
a process of effecting the dispensations of monetary compensations for a plurality of physicians relating to said physicians' treatments on a plurality of patients;
a process of effecting the dispensations of monetary compensations for a plurality of physicians relating to said physicians' treatments on a plurality of patients;
a process of effecting the dispensations of monetary compensations for a physician relating to said physician's treatments on a patient;
a process of effecting a dispensation of monetary compensation for a physician relating to said physician's procedure or procedures on a patient;
a process of effecting a dispensation of monetary compensations for a physician relating to said physician's procedure or procedures on a plurality of patients;
a process of effecting the dispensations of monetary compensations for a plurality of physicians relating to said physicians' procedures on a patient;
a process of effecting a dispensation of monetary compensation for a physician relating to said physicians' procedure or procedures on a patient or a plurality of patients;
a process of effecting the dispensations of monetary compensations for a plurality of physicians relating to said physicians' procedures on a plurality of patients;
a process of effecting a dispensation of monetary compensations for a physician relating to said physician's procedure or a plurality of procedures on a patient or a plurality of patients;
a process of effecting the dispensations of monetary compensations for a plurality of physicians relating to said physicians' procedures on a patient;
a process of effecting the dispensations of monetary compensations for a plurality of physicians relating to said physicians' procedures on a patient or a plurality of patients a process of using a means for compensating a physician formed by the consumers of health-care services;
a process of using a means for compensating a physician formed by the buyers of health-care services;
a process of using a means for compensating a plurality of physicians formed by the consumers of health-care services;
a process of using a means for compensating a plurality of physicians formed by the buyers of health-care services;
a process of using a means for compensating a physician formed by the consumers-buyers of health-care services;
a process of using a means for compensating a plurality of physicians formed by the consumers-buyers of health-care services;
a process of using an electronic means for transmitting a monetary compensation to a physician;
a process of using an electronic means for transmitting monetary compensations to a physician;
a process of using an electronic means for transmitting a monetary compensation to a plurality of physicians;
a process of using an electronic means for transmitting monetary compensations to a plurality of physicians;
a process of using a means for receiving a monetary compensation for a physician;
a process of using a means for receiving monetary compensations for a physician;
a process of using a means for receiving a monetary compensation for a plurality of physicians;
a process of using a means for receiving monetary compensations for a plurality of physicians;
a process of using an electronic means for receiving a monetary compensation for a physician; and
a process of using an electronic means for receiving monetary compensations for a plurality of physicians.

2. The method of increasing the productivity of a physician according to claim 1 wherein said process of effecting a dispensation of monetary compensations for a physician relating to a treatment or a plurality of treatments of a patient includes a process of endorsing said dispensation by said patient.

3. The method of increasing the productivity of a physician according to claim 1 wherein said process of effecting the dispensations of monetary compensations for a plurality of physicians relating to said physicians' treatments of a patient or a plurality of patients includes a process of endorsing said dispensations by said patient or patients.

4. The method of increasing the productivity of a physician according to claim 1 wherein said process of effecting a dispensation of monetary compensations for a physician relating to said physician's treatment on a patient or a plurality of patients includes a process of endorsing said dispensation by a buyer of the health-care services being consumed by said patient or patients.

5. The method of increasing the productivity of a physician according to claim 1 wherein said process of effecting the dispensations of monetary compensations for a plurality of physicians relating to said physicians' treatments on a plurality of patients includes a process of endorsing said dispensations by a plurality of buyers of the health-care services being consumed by said patients.

6. The method of increasing the productivity of a physician according to claim 1 wherein said process of effecting the dispensations of monetary compensations for a physician relating to said physician's treatments on a patient includes a process of endorsing said dispensations by a plurality of buyers of the health-care services being consumed by said patient.

7. The method of increasing the productivity of a physician according to claim 1 wherein said process of effecting a dispensation of monetary compensation for a physician relating to said physician's procedure or procedures on a patient includes a process of endorsing said dispensation by said patient.

8. The method of increasing the productivity of a physician according to claim 1 wherein said process of effecting a dispensation of monetary compensations for a physician relating to said physician's procedure or procedures on a plurality of patients includes a process of endorsing said dispensation by said patients.

9. The method of increasing the productivity of a physician according to claim 1 wherein said process of effecting the dispensations of monetary compensations for a plurality of physicians relating to said physicians' procedures on a patient includes a process of endorsing said dispensations by said patient.

10. The method of increasing the productivity of a physician according to claim 1 wherein said process of effecting a dispensation of monetary compensation for a physician relating to said physicians' procedure or procedures on a patient or a plurality of patients includes a process of endorsing said dispensation by said patient or patients.

11. The method of increasing the productivity of a physician according to claim 1 wherein said process of effecting the dispensations of monetary compensations for a plurality of physicians relating to said physicians' procedures on a plurality of patients includes a process of endorsing said dispensations by said patients.

12. The method of increasing the productivity of a physician according to claim 1 wherein said process of effecting a dispensation of monetary compensations for a physician relating to said physician's procedure or a plurality of procedures on a patient or a plurality of patients includes a process of endorsing said dispensation for said physician by a buyer of the health-care services being consumed by said patient or patients.

13. The method of increasing the productivity of a physician according to claim 1 wherein said process of effecting the dispensations of monetary compensations for a plurality of physicians relating to said physicians' procedures on a patient includes a process of endorsing said dispensations by a buyer of the health-care services being consumed by said patient.

14. The method of increasing the productivity of a physician according to claim 1 wherein said process of effecting the dispensations of monetary compensations for a plurality of physicians relating to said physicians' procedures on a patient or a plurality of patients includes a process of endorsing said dispensations by a plurality of buyers of the health-care services being consumed by said patient or patients.

15. A method of securing the monetary payments for and due to a physician or a plurality of physicians for the health-care services provided by said physicians to a patient or a plurality of patients who are the consumers of said services wherein each said physician is not compelled or obligated to lose the physicians' time dealing with and doing paper-works relating to the pursuit of said payments being derived from the contributions of said patients, employers, buyers of said services or any combination thereof, wherein data comprising said physician's treatment, plurality of treatments of, procedure or plurality of procedures on a patient formed or synthesized in said physician's brain and mind, upon prompting by said physician, are converted or synthesized by said physician into said physician's spoken voice data, wherein said voice data are articulated by said physician and received by a first receiver means for propagating said data, wherein said data are transmitted by a wireless means for transmitting adaptable to propagate said data to a second receiver means for propagating said data adaptable to further propagate said data to a means for assigning or correlating individual monetary value or values to said treatment, plurality of treatments, procedure or plurality of procedures, a means for enumerating or tallying individual monetary values of said treatment, plurality of treatments, procedure or plurality of procedures and a means for effecting dispensations of monetary compensations relating to said treatment, plurality of treatments, procedure, plurality of procedures from a means for compensating formed by the consumers, buyers or consumers-buyers of health-care services to a physician, a plurality of physicians or to a receiver of compensations of a physician or a plurality of physicians comprises:
a process of converting said data into said physician's spoken voice data;
a process of synthesizing said data into said physician's spoken voice data;
a process of articulating said spoken voice data by said physician;
a process of articulating said voice data by said physician into a first receiver means for propagating said voice data;
a process of transmitting said voice data by a wireless means for transmitting data;
a process of transmitting said voice data by a wireless means for transmitting data to a second receiver means for propagating said data;
a process of using a means for assigning individual monetary value to a treatment;
a process of using a means for assigning individual monetary value to a procedure;
a process of using a means for assigning individual monetary values relating to a plurality of treatments;
a process of using a means for assigning individual monetary values to a plurality of procedures;
a process of using a means for tallying individual monetary values relating to a plurality of treatments;
a process of using a means for tallying individual monetary values relating to a plurality of procedures;
a process of effecting a dispensation of monetary compensations for a physician relating to a treatment or a plurality of treatments of a patient;
a process of effecting the dispensations of monetary compensations for a plurality of physicians relating to said physicians' treatments of a patient or a plurality of patients;
a process of effecting a dispensation of monetary compensations for a physician relating to said physician's treatment on a patient or a plurality of patients;
a process of effecting the dispensations of monetary compensations for a plurality of physicians relating to said physicians' treatments on a plurality of patients;
a process of effecting the dispensations of monetary compensations for a plurality of physicians relating to said physicians' treatments on a plurality of patients;
a process of effecting the dispensations of monetary compensations for a physician relating to said physician's treatments on a patient;
a process of effecting a dispensation of monetary compensation for a physician relating to said physician's procedure or procedures on a patient;
a process of effecting a dispensation of monetary compensations for a physician relating to said physician's procedure or procedures on a plurality of patients;
a process of effecting the dispensations of monetary compensations for a plurality of physicians relating to said physicians' procedures on a patient;
a process of effecting a dispensation of monetary compensation for a physician relating to said physicians' procedure or procedures on a patient or a plurality of patients;
a process of effecting the dispensations of monetary compensations for a plurality of physicians relating to said physicians' procedures on a plurality of patients;
a process of effecting a dispensation of monetary compensations for a physician relating to said physician's procedure or a plurality of procedures on a patient or a plurality of patients;
a process of effecting the dispensations of monetary compensations for a plurality of physicians relating to said physicians' procedures on a patient;
a process of effecting the dispensations of monetary compensations for a plurality of physicians relating to said physicians' procedures on a patient or a plurality of patients
a process of using a means for compensating a physician formed by the consumers of health-care services;
a process of using a means for compensating a physician formed by the buyers of health-care services;
a process of using a means for compensating a plurality of physicians formed by the consumers of health-care services;
a process of using a means for compensating a plurality of physicians formed by the buyers of health-care services;
a process of using a means for compensating a physician formed by the consumers-buyers of health-care services;
a process of using a means for compensating a plurality of physicians formed by the consumers-buyers of health-care services;
a process of using an electronic means for transmitting a monetary compensation to a physician;
a process of using an electronic means for transmitting monetary compensations to a physician;
a process of using an electronic means for transmitting a monetary compensation to a plurality of physicians;
a process of using an electronic means for transmitting monetary compensations to a plurality of physicians;
a process of using a means for receiving a monetary compensation for a physician;
a process of using a means for receiving monetary compensations for a physician;
a process of using a means for receiving a monetary compensation for a plurality of physicians;
a process of using a means for receiving monetary compensations for a plurality of physicians;
a process of using an electronic means for receiving a monetary compensation for a physician; and
a process of using an electronic means for receiving monetary compensations for a plurality of physicians.

16. A method of reducing the economic loss and legal encumbrances being caused by the third parties on the physicians wherein data comprising said physician's treatment, plurality of treatments of, procedure or plurality of procedures on a patient formed or synthesized in said physician's brain and mind, upon prompting by said physician, are converted or synthesized by said physician into said physician's spoken voice data, wherein said voice data are articulated by said physician and received by a first receiver means for propagating said data, wherein said data and physician-patient conversations including physician's explanations leading to patient's informed consent are transmitted by a wireless means for transmitting adaptable to propagate said data and conversations to a second receiver means for propagating said data adaptable to further propagate said data to a means for assigning or correlating individual monetary value or values to said treatment, plurality of treatments, procedure or plurality of procedures, a means for enumerating or tallying individual monetary values of said treatment, plurality of treatments, procedure or plurality of procedures and a means for effecting dispensations of monetary compensations relating to said treatment, plurality of treatments, procedure, plurality of procedures from a means for compensating formed by the consumers, buyers or consumers-buyers of health-care services to a physician, a plurality of physicians or to a receiver of compensations of a physician or a plurality of physicians comprises:
a process of converting said data into said physician's spoken voice data;
a process of synthesizing said data into said physician's spoken voice data;
a process of articulating said spoken voice data by said physician;
a process of articulating said voice data by said physician into a first receiver means for propagating said voice data;
a process of transmitting said voice data by a wireless means for transmitting data;
a process of transmitting said voice data by a wireless means for transmitting data to a second receiver means for propagating said data;
a process of using a means for assigning individual monetary value to a treatment;
a process of using a means for assigning individual monetary value to a procedure;
a process of using a means for assigning individual monetary values relating to a plurality of treatments;
a process of using a means for assigning individual monetary values to a plurality of procedures;
a process of using a means for tallying individual monetary values relating to a plurality of treatments;
a process of using a means for tallying individual monetary values relating to a plurality of procedures;
a process of effecting a dispensation of monetary compensations for a physician relating to a treatment or a plurality of treatments of a patient;
a process of effecting the dispensations of monetary compensations for a plurality of physicians relating to said physicians' treatments of a patient or a plurality of patients;
a process of effecting a dispensation of monetary compensations for a physician relating to said physician's treatment on a patient or a plurality of patients;
a process of effecting the dispensations of monetary compensations for a plurality of physicians relating to said physicians' treatments on a plurality of patients;
a process of effecting the dispensations of monetary compensations for a plurality of physicians relating to said physicians' treatments on a plurality of patients;
a process of effecting the dispensations of monetary compensations for a physician relating to said physician's treatments on a patient;
a process of effecting a dispensation of monetary compensation for a physician relating to said physician's procedure or procedures on a patient;
a process of effecting a dispensation of monetary compensations for a physician relating to said physician's procedure or procedures on a plurality of patients;
a process of effecting the dispensations of monetary compensations for a plurality of physicians relating to said physicians' procedures on a patient;
a process of effecting a dispensation of monetary compensation for a physician relating to said physicians' procedure or procedures on a patient or a plurality of patients;
a process of effecting the dispensations of monetary compensations for a plurality of physicians relating to said physicians' procedures on a plurality of patients;
a process of effecting a dispensation of monetary compensations for a physician relating to said physician's procedure or a plurality of procedures on a patient or a plurality of patients;
a process of effecting the dispensations of monetary compensations for a plurality of physicians relating to said physicians' procedures on a patient;
a process of effecting the dispensations of monetary compensations for a plurality of physicians relating to said physicians' procedures on a patient or a plurality of patients
a process of using a means for compensating a physician formed by the consumers of health-care services;
a process of using a means for compensating a physician formed by the buyers of health-care services;
a process of using a means for compensating a plurality of physicians formed by the consumers of health-care services;
a process of using a means for compensating a plurality of physicians formed by the buyers of health-care services;
a process of using a means for compensating a physician formed by the consumers-buyers of health-care services;
a process of using a means for compensating a plurality of physicians formed by the consumers-buyers of health-care services;
a process of using an electronic means for transmitting a monetary compensation to a physician;
a process of using an electronic means for transmitting monetary compensations to a physician;
a process of using an electronic means for transmitting a monetary compensation to a plurality of physicians;
a process of using an electronic means for transmitting monetary compensations to a plurality of physicians;
a process of using a means for receiving a monetary compensation for a physician;
a process of using a means for receiving monetary compensations for a physician;
a process of using a means for receiving a monetary compensation for a plurality of physicians;
a process of using a means for receiving monetary compensations for a plurality of physicians;
a process of using an electronic means for receiving a monetary compensation for a physician;
a process of using an electronic means for receiving monetary compensations for a plurality of physicians; and
a process of documenting physician-patient conversations including explanations leading to a patient's informed consents.
